(19) United States
(12) Patent Application Publication
(10) Pub. No.: US 2008/0064249 A1
(43) Pub. Date: Mar. 13, 2008

(54) Auxiliary device for a connector

(75) Inventors: Lien-Hsun Ho, Taipei (TW); Yuan-Liang Hsu, Taipei (TW); Shou-Ting Yeh, Taipei (TW); Chuan-Hsing Wu, Taipei (TW); Tung-Yuan Chen, Taipei (TW); Chao-Yi Wu, Taipei (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: CYBER POWER SYSTEM INC., Taipei (TW)

(21) Appl. No.: 11/518,348

(22) Filed: Sep. 8, 2006

(51) Int. Cl. H01R 13/627

(52) U.S. Cl. 439/352

(57) ABSTRACT

An auxiliary device for a connector has a body, a wire unit and plug. The wire unit is mounted securely in the body and extends out of the body from a first end of the body. The plug is formed on a second end of the body and is perpendicular to the wire unit. Therefore, the position of the wire unit is fixed when the plug is inserted into a socket.

### BACKGROUND OF THE INVENTION

1. Field of the Invention

The present invention relates to an auxiliary device for a connector and, more particularly to an auxiliary device which is used to insert a plug into a socket.

2. Description of the Related Art

With the development of the industry, electrical devices are designed to be small to be portable.

With reference to FIGS. 8 and 9, a conventional power supply has a base (60) and a cap (61). The base (60) has a socket (62) and a wire unit (70) with a battery (72) mounted in the base (60) to supply power. A plug (71) is mounted on an end of the wire unit (70), and connects to the socket (62) to conduct power.

However, the socket (62) is mounted on a bottom of the base (60) and is mounted between the battery (72) and a shell such that the plug (71) is difficult to be inserted into the socket (62) by a finger of a user. Furthermore, the wire unit (70) is not fastened, so that the position of the wire unit (70) is not fixed. When the cap (61) is closed on the base (60), the cap (61) is easy to be blocked by the wire unit (70).

Therefore, the invention provides an auxiliary device for a connector to mitigate or obviate the aforementioned problems.

### SUMMARY OF THE INVENTION

The main objective of the present invention is to provide an auxiliary device for a connector which can be used for inserting a plug into a socket.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an auxiliary device for a connector in accordance with the present invention;

FIG. 2 is an exploded perspective view of the auxiliary device for a connector in FIG. 1;

FIG. 3 is a top view of a power supply with the auxiliary device for a connector in FIG. 1;

FIG. 4 is a partially enlarged operational side view in partial section of the power supply in FIG. 3;

FIG. 5 is a partially enlarged operational side view in partial section of the power supply in FIG. 3 when a plug is inserted into a socket;

FIG. 6 is a top view of the power supply in FIG. 3 with the auxiliary device for a connector when the plug is inserted into the socket;

FIG. 7 is a front view of the power supply in FIG. 3 with the auxiliary device for a connector when the plug is inserted into the socket;

FIG. 8 is a partially enlarged side view in partial section of the conventional power supply in accordance with the prior art; and

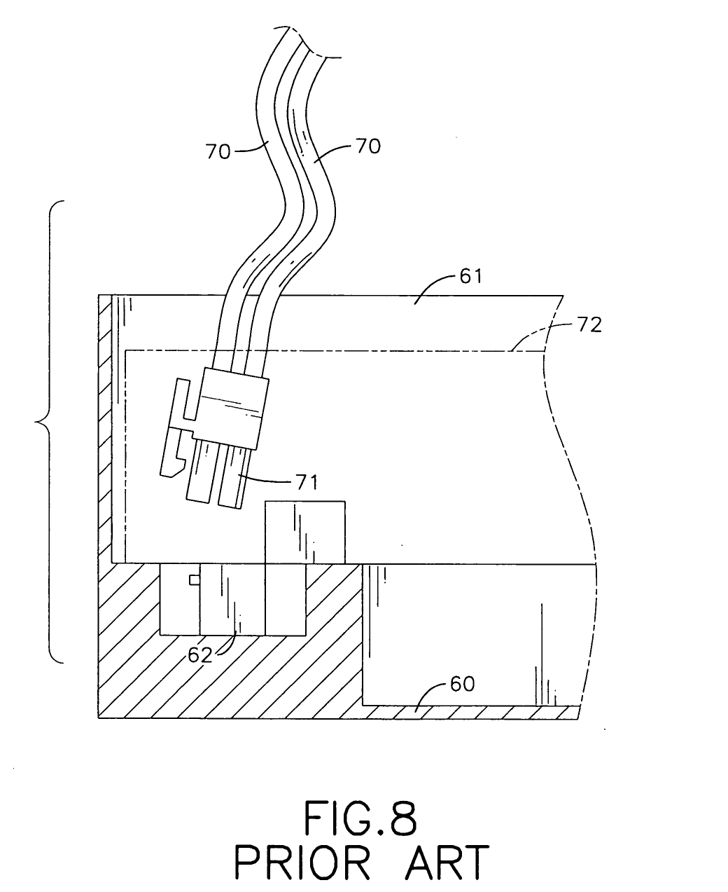

FIG. 9 is a top view of the conventional power supply in FIG. 8.

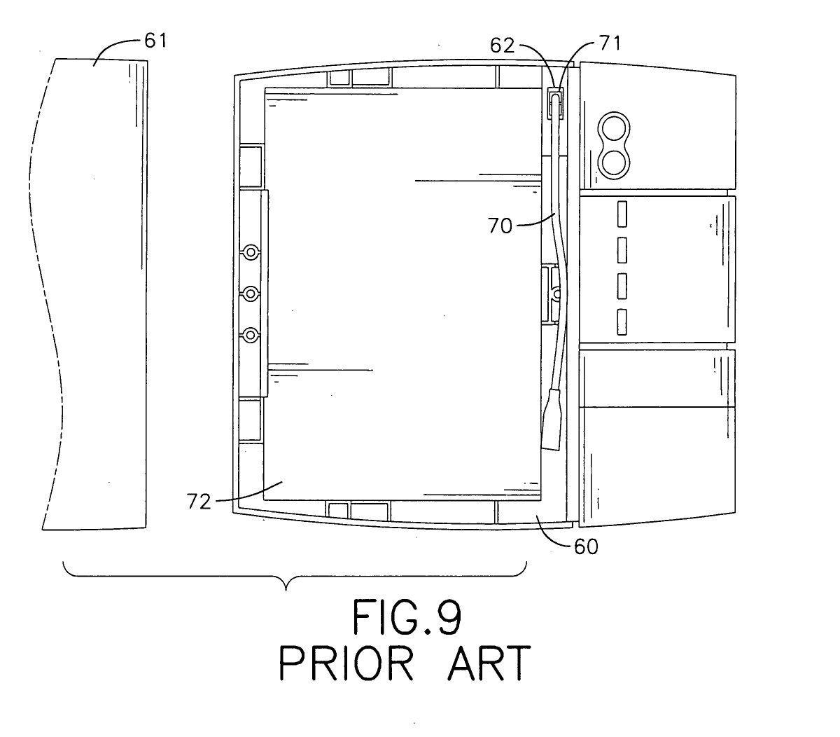

### DETAILED DESCRIPTION OF THE PREFERRED EMBODIMENT

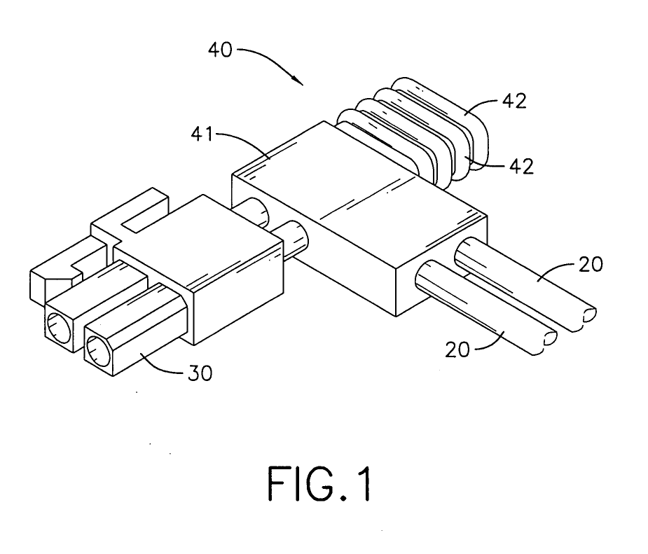

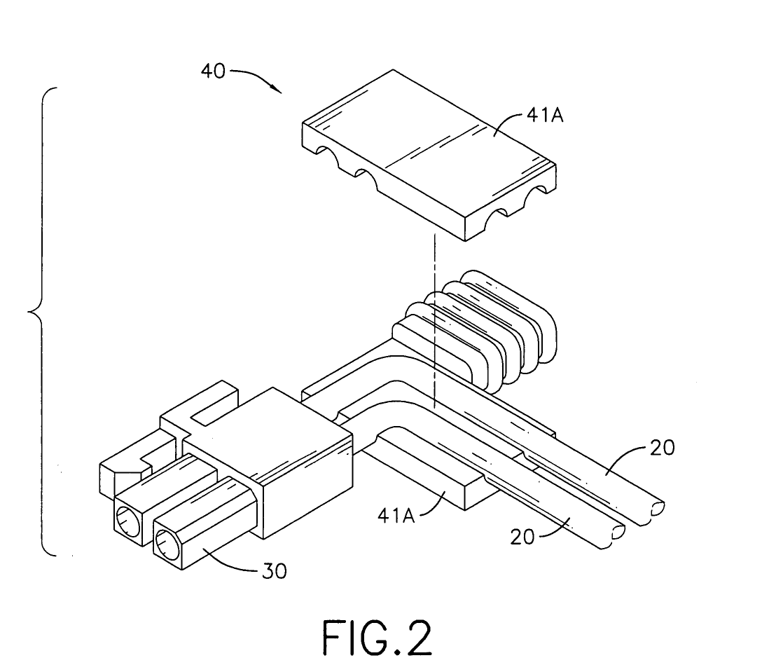

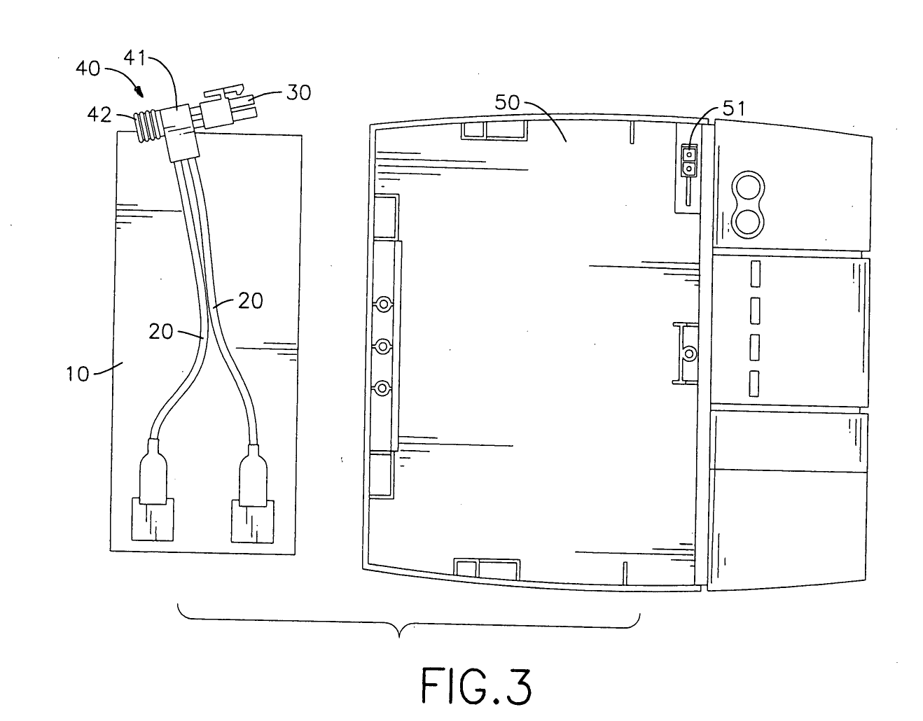

With reference to FIGS. 1-3, an auxiliary device (40) for a connector in accordance with the present invention is made of plastic, has an L-like shape and connects to a power supply with an electrical device (10). The auxiliary device (40) has a body (41), multiple evenly-spaced ribs (42) formed in a third end of the body (41), a wire unit (20) and a plug (30).

The electrical device (10) has an anode and a cathode.

The wire unit (20) is formed transversely in the body (41) and extends out of a first end of the body (41) and opposite to a fourth end of the body. An end of the wire unit (20) is connected to the anode or the cathode of the power supply. The plug (30) is mounted in a second end of the body (41), opposite to the multiple, evenly spaced ribs (42) and is perpendicular to the wire unit (20). The second and third ends extend between the first and fourth ends of the body (41). The position of the wire unit (20) is fixed relative to the body (41).

The body (41) may have two separate portions 41A.

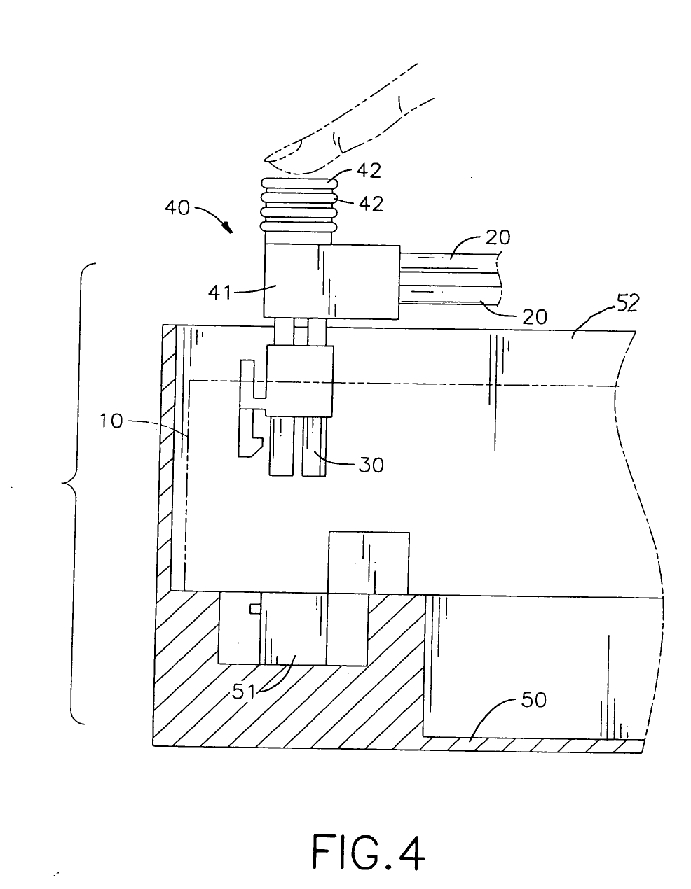

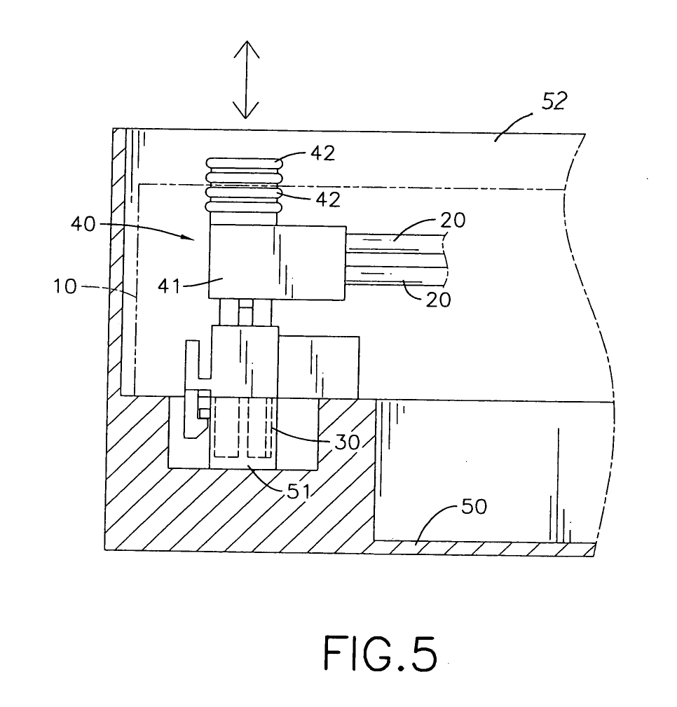

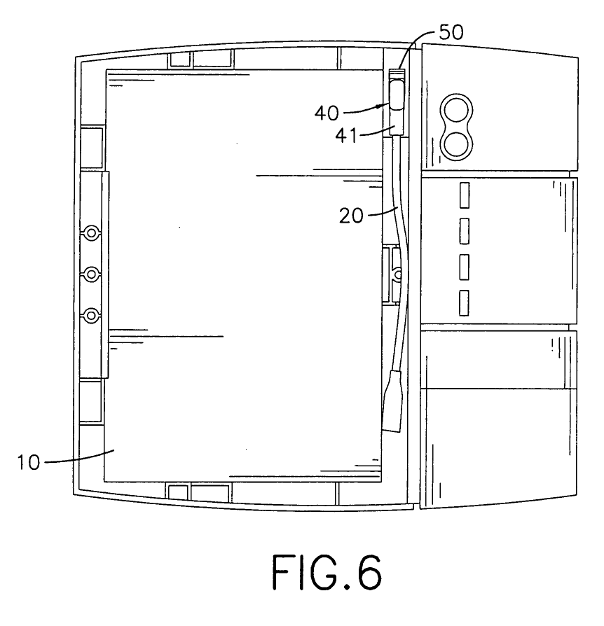

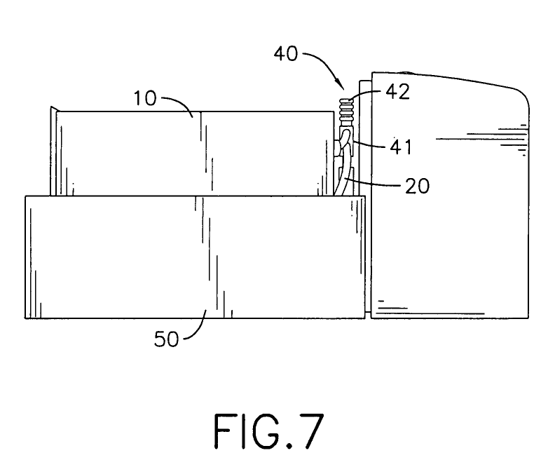

An electrical product has a base (50), a socket (51) formed in the base (50), and a cap (52). With further reference to FIG. 4-7, the electrical device (10) is provided on the base (50). With the ribs (42), the user can conveniently hold the plug (30) to insert into and to engage the socket (51).

Furthermore, the wire unit (20) can be positioned so that the cap (52) can be smoothly mounted onto the base (50).

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

1. An auxiliary device for a connector comprising:
a body having first, second, third and fourth ends, with the second and third ends beina spaced and extending perpendicularly between both the first and fourth ends, with the first and fourth ends being spaced.
a wire unit mounted transversely in the body and extending out of the first end of the body opposite to the fourth end;
a plug mounted in the second end of the body and being perpendicular to the wire unit; and
multiple evenly spaced ribs formed on the third end of the body, and opposite to the plug and intermediate and extending beyond the second and fourth ends, with each of the multiple evenly spaced ribs being parallel to the third end and of an annular shape parallel to the third end, with the multiple evenly spaced ribs being spaced from each other in a direction nerpendicular to the third end and opposite to the second end, with the direction being parallel to the first and fourth ends, with the wire unit being intermediate the multiple evenly spaced ribs and the plug, with the multiple evenly spaced ribs being held by a user to insert the plug.

2. The auxiliary device for a connector as claimed in claim 1, wherein the body is one-piece and is made of plastic.

3. The auxiliary device for a connector as claimed in claim 1, wherein the body comprises two portions.

4. (canceled)
